(19) United States
(12) Patent Application Publication
(10) Pub. No.: US 2026/0075689 A1
(43) Pub. Date: Mar. 12, 2026

(54) LED DECORATIVE LIGHT WITH CODE WRITING TRIGGERED BY AN EXTERNAL SIGNAL

(71) Applicant: HANGZHOU YUN LED CHIP PHOTOELECTRICITY TECH. CO., LTD., Hangzhou (CN)

(72) Inventors: Yinghan YANG, Hangzhou (CN); Zixun ZHANG, Hangzhou (CN)

(73) Assignee: HANGZHOU YUN LED CHIP PHOTOELECTRICITY TECH. CO., LTD., Hangzhou (CN)

(21) Appl. No.: 19/390,601

(22) Filed: Nov. 16, 2025

Related U.S. Application Data
(63) Continuation of application No. PCT/CN2024/086740, filed on Apr. 9, 2024.

(30) Foreign Application Priority Data
May 25, 2023 (CN) 202310599185.1

(51) Int. Cl. H05B 45/30; H05B 45/10

(52) U.S. Cl. CPC H05B 45/30; H05B 45/10

(57) ABSTRACT

A light-emitting diode (LED) decorative light with code writing triggered by an external signal, includes: a controller and a light string. A positive terminal and a negative terminal of the controller are connected to the light string. The controller supplies power to the light string through the positive terminal and the negative terminal, and loads a control signal on the positive terminal or/and the negative terminal. The light string includes a plurality of code-writable LED modules. After receiving an external signal, the code-writable LED modules complete code writing according to the control signal. Highly efficient code writing for LED modules through external signal triggering can be achieved, thereby avoiding address code writing errors caused by writing addresses during the assembly of LED modules into the light string, and preventing the instability and unreliability of determining LED module address codes based on their positions in the LED light string.

### CROSS-REFERENCE TO RELATED APPLICATIONS

The present application is a continuation of International Patent Application No. PCT/CN2024/086740 filed on April 9, 2024, which claims priority to Chinese Patent Application No. CN 202310599185.1 filed on May 25, 2023. The disclosures of the above-referenced applications are hereby incorporated by reference in their entirety.

### BACKGROUND

Currently, multi-color light-emitting diode (LED) decorative lights with address codes have emerged on the market. Each LED decorative light includes a controller and a plurality of LED modules. Each LED module has a built-in driver chip and a controlled light-emitting diode. Each built-in driver chip includes an address module, into which a fixed address code is written. The driver chip compares the signals loaded by the controller with the written fixed address code/address code/code, enabling individual control of each LED module corresponding to its address code.

### SUMMARY

The present disclosure relates to the field LED decorative lights, specifically to an LED decorative light with code writing triggered by an external signal.

An object of the present disclosure is to provide an LED decorative light with code writing triggered by an external signal, which can be triggered by an external signal to achieve address code writing for the LED modules.

An LED decorative light with code writing triggered by an external signal is wherein the LED decorative light can include the following.

A controller and a light string.

A positive terminal and a negative terminal of the controller are connected to the light string. The controller supplies power to the light string through the positive terminal and the negative terminal, and loads a control signal on the positive terminal or/and the negative terminal.

The light string includes a plurality of code-writable LED modules.

The code-writable LED module, after receiving an external signal, completes code writing according to a control signal loaded on its positive terminal or/and its negative terminal. The code-writable LED module refers to one of the plurality of code-writable LED modules. The external signal is applied not via the power terminals (positive/negative) of the code-writable LED module, but via an external interface.

It should be understood that loading the control signal on the positive terminal or/and the negative terminal means that the control signal can be loaded solely on the positive terminal, solely on the negative terminal, or jointly on both the positive and negative terminals. Loading the control signal on the positive terminal or/and the negative terminal essentially means loading the control signal at the power output terminals.

The code-writable LED module includes: a driver chip and a controlled LED. The driver chip receives the control signal and drives the controlled LED to achieve controllable effects. It should be understood that the controllable effects may be a fixed color and brightness level, a fixed blinking pattern, or other controllable effects.

Upon receiving the external signal, the driver chip is set into a code-writing state and completes the code writing process according to the control signal. The control signal includes an address signal.

Preferably, the driver chip includes a photosensitive module. The external signal is a lightwave. After the photosensitive module receives the lightwave, the driver chip completes code writing based on the control signal.

Preferably, the lightwave is a laser of a fixed wavelength. After the code-writable LED decorative light is powered on, the laser irradiates the code-writable LED module. The photosensitive module receives the laser, setting the driver chip into a code-writing state, and the driver chip completes code writing based on the control signal.

Preferably, the control signal includes an address signal.

As another implementation, the driver chip includes a thermosensitive module, and the external signal is a temperature change signal. After the thermosensitive module receives the temperature change signal, the driver chip completes code writing based on the control signal.

Preferably, the temperature change signal is a temperature exceeding 100 degrees Celsius. When the thermosensitive module detects a temperature exceeding 100 degrees Celsius, the driver chip enters a code-writing state and completes code writing according to the control signal.

Preferably, the driver chip includes a magnetic signal sensing module, and the external signal is a magnetic change signal. After the magnetic signal sensing module receives the magnetic change signal, the driver chip completes code writing based on the control signal.

Preferably, the magnetic signal sensing module is a first coil. After the first coil senses the magnetic change signal, the first coil senses an induced current generated by magnetic signal change to set the driver chip into a code-writing state. The driver chip receives the control signal, enters the code-writing state, decodes an address signal in the control signal, and completes code writing.

As another implementation, the driver chip includes a high-frequency electromagnetic wave sensing module, and the external signal is a high-frequency electromagnetic wave signal. After the high-frequency electromagnetic wave sensing module receives the high-frequency electromagnetic wave signal, the driver chip completes code writing based on the control signal.

Preferably, the high-frequency electromagnetic wave sensing module is a second coil. When the second coil receives the high-frequency electromagnetic wave signal, it induces a high-frequency electrical signal, triggering the driver chip to enter a code-writing state. The driver chip decodes the address signal included in the control signal and completes code writing. Preferably, the frequency of the high-frequency electromagnetic wave signal is greater than 10 kHz.

Preferably, the driver chip is triggered by the control signal to perform operations, and the operation results of the driver chip drive the controlled LED.

Preferably, the control signal includes an address signal. The driver chip receives the address signal and compares it with the driver chip's address. When the received address signal matches the driver chip's address, the control signal is executed.

It should be understood that the plurality of code-writable LED modules can form the light string in a fully parallel configuration, in a series configuration, in a parallel-then-series configuration, or in a series-then-parallel configuration.

Preferably, the operations may be arithmetic operations, logical operations, or a combination of arithmetic and logical operations.

Preferably, the driver chip performs pulse counting operations based on the control signal.

As another operational method, the driver chip performs encoding or decoding operations on the control signal, where the pulse high-level/low-level widths of the control signal correspond to encoded information.

As a preferred implementation of the encoding/decoding operations, different high-level durations, different low-level durations, or combinations of different high-level and low-level durations in the control signal represent different logical encoding information.

As another operational method, the driver chip performs modulation/demodulation operations on the control signal based on current or voltage frequency, and drives the controlled LED according to the results of these modulation/demodulation operations.

Preferably, the controller of the LED decorative light includes a controllable switch module through which the control signal is loaded.

As a preferred solution for loading the control signal, the controllable switch module includes a first controllable switch and an intermediate level module. When the first controllable switch is turned off, the intermediate level module forms a second level, and the control signal is loaded by switching between the supply level and the second level. The second level is higher than the reference ground and lower than the supply level.

As another solution for loading the control signal, the control signal is loaded by controlling the turning ON and OFF of the controllable switch module. It should be understood that when the control signal is loaded through the turning ON and OFF of the controllable switch module, the code-writable LED module receives power supply while simultaneously receiving pulse signals, rising edge signals, or falling edge signals formed by the switching actions of the controllable switch module.

As another solution for loading the control signal, the controllable switch module is a first controllable switch, and the control signal is loaded by controlling the turning ON and OFF of the first controllable switch.

The present disclosure completes code writing for LED modules through external signal triggering, avoiding address code writing errors that occur when addresses are written during LED module assembly into the light string, and preventing the instability and unreliability of determining LED module address codes based on their positions in the LED light string, thereby achieving a highly efficient code-writable LED decorative light.

### BRIEF DESCRIPTION OF THE DRAWINGS

To more clearly illustrate the embodiments of the disclosure, the following is a brief description of the drawings, which are for illustrative purpose only. For those of ordinary skills in the art, other drawings of other embodiments can become apparent based on these drawings.

FIG. 1 illustrates an LED decorative light with code writing triggered by an external signal in a fully parallel configuration according to an embodiment.

FIG. 2 shows a code-writable LED module in the embodiment.

FIG. 3 depicts a driver chip in the embodiment.

FIG. 4 illustrates a controller in the embodiment

### DETAILED DESCRIPTION

For existing LED decorative lights with address codes, the address code is written into the driver chip when the LED modules are assembled into the light string. The writing method not only complicates the assembly of LED modules but is also prone to errors in address code writing, resulting in elevated production costs. For example, the Chinese patent with publication number CN103268751A discloses an address code writing system for an LED display device, which includes a setting module and a main control module. The setting module generates a preset address code and a preset series number value based on user settings, and the main control module writes the preset address code into the LED display device. Another Chinese patent with publication number CN113744685A discloses an address writing system for an LED display module, which includes a main control unit and display modules. N*M display modules are arranged in a rectangular array, with M display modules in the same column connected in series, and the first display modules of N columns sequentially connected to the main control unit. The main control unit is equipped with an address output module that outputs addresses to the first display modules of the N columns. The display modules are equipped with an address processing module, which, after receiving an address, processes the address according to a vertical increment rule, writes the processed address as its own address, and outputs its own address to the next display module.

The U.S. patent "LIGHT EMITTING DIODE LAMP WITH BURNABLE FUNCTION AND LIGHT EMITTING DIODE LAMP STRING WITH BURNABLE FUNCTION" (Patent No.: US 10,187,935 B2) discloses that a light emitting diode driving apparatus receives a burn start signal and burn address data sent through a first contact. After receiving the burn start signal, the light emitting diode driving apparatus burns the burn address data as local address data into the apparatus.

The inventors of the present disclosure have recognized that some related studies have explored light strings that do not contain fixed address codes. Instead, the address codes of the LED modules are determined based on their positions in the LED light string, utilizing the differential characteristics of equivalent resistance and equivalent capacitance of the light string structure. However, this implementation leads to high costs for the driver chips of the LED modules, and their stability and reliability are less than ideal.

As such, various embodiments of the present disclosure can address how to provide a highly reliable and cost-effective code-writable LED decorative light.

The present disclosure will now be described in further detail below with reference to the accompanying drawings and specific embodiments.

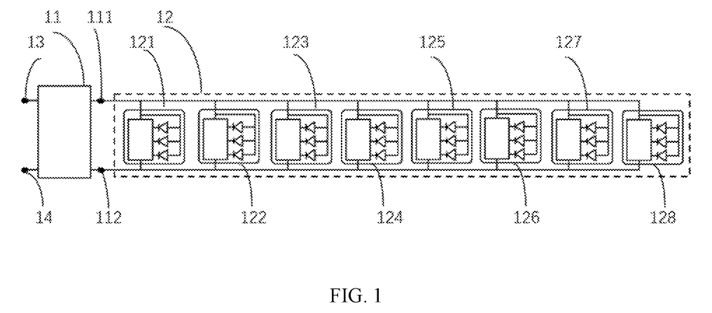

As shown in FIG. 1, some embodiments of the present disclosure can include the following.

A controller 11 and a light string 12.

The controller supplies power to the light string 12 via the positive terminal 111 and the negative terminal 112, and loads a control signal on the negative terminal 112.

The light string 12 includes eight code-writable LED modules connected in parallel, namely 121, 122, 123, 124, 125, 126, 127, and 128.

The controller is connected to the positive terminal of a 3.3V power supply at input terminal 13, and to the negative terminal of the 3.3V power supply at input terminal 14.

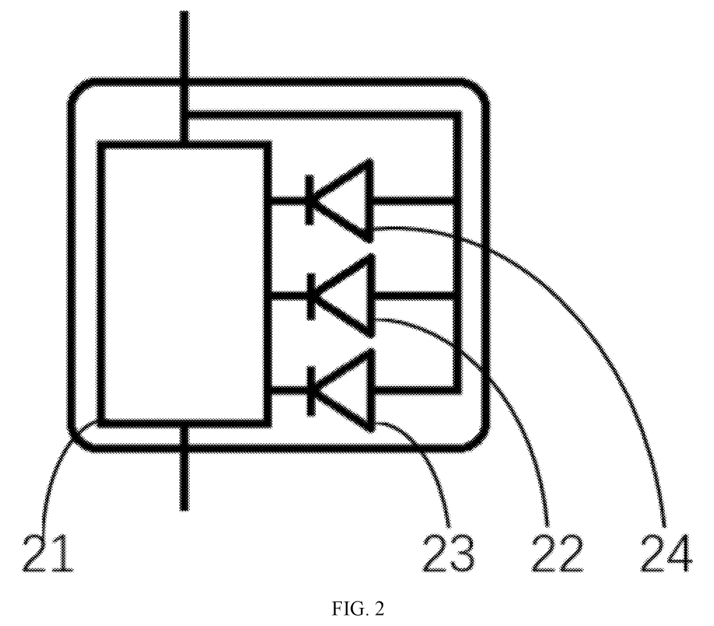

The structure of the code-writable LED module is shown in FIG. 2. The code-writable LED modules 121, 122, 123, 124, 125, 126, 127, and 128 in the LED decorative light of the embodiment all adopt the structure illustrated in FIG. 2. As shown in FIG. 2, the code-writable LED module includes a driver chip 21, a red light-emitting diode 22, a green light-emitting diode 23, and a blue light-emitting diode 24. The driver chip 21 receives the control signal and controls the red light-emitting diode 22, green light-emitting diode 23, and blue light-emitting diode 24 to achieve controllable functions.

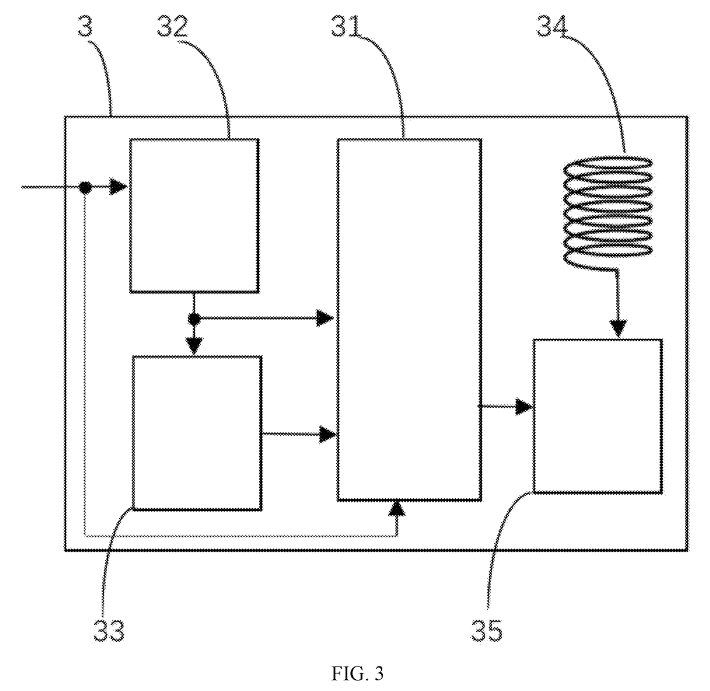

The structure of the driver chip 3 is shown in FIG. 3 (the driver chip 21 adopts the structure shown in FIG. 3). The driver chip 3 includes: a control signal triggering operation unit 31, configured to perform operations based on the control signal input from the power line and output the operation result; a charging unit 32, configured to provide a supply voltage to the control signal triggering operation unit 31 based on the control signal input from the power line, charging when the control signal is at a high level and discharging when the control signal is at a low level; an initialization unit 33, configured to initialize the control signal triggering operation unit 31 based on the supply voltage provided by the charging unit 32; a first coil 34, configured to sense external high-frequency electromagnetic signals; and a code writing module 35, configured to, upon receiving the induction signal from the first coil 34, complete code writing based on the operation result of the control signal triggering operation unit 31.

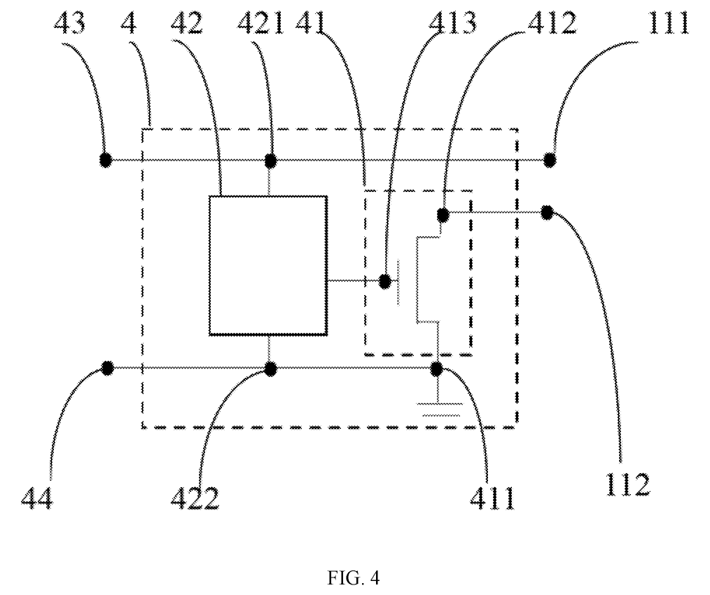

As shown in FIG. 4, the controller 4 (the controller 11 in the embodiment adopts the structure shown in FIG. 4) includes an NMOS 41 acting as a controllable switch: the drain 411 of the NMOS 41 is grounded, the source 412 serves as the output negative terminal 112 of the controller 4, and the gate 413 is connected to a microprocessor 42; the input terminal 43 of the controller 4 is connected to the positive terminal of the 3.3V power supply and serves as the output positive terminal 111 of the controller, and the input terminal 44 of the controller 4 is connected to the negative terminal of the 3.3V power supply and is commonly grounded with the drain 411 of the NMOS 41; the power supply terminal 421 of the microprocessor 42 is connected to the input terminal 43 of the controller 4, the ground terminal 422 of the microprocessor 42 is connected to the input terminal 44 of the controller 4, and the input terminal 44 of the controller 4 is connected to the negative terminal of the 3.3V power supply. By running a software program on the microprocessor 42, the switching of the NMOS 41 is controlled to form the control signal, which is loaded onto the negative power line.

The above descriptions are merely preferred embodiments of the present disclosure and are not intended to limit the disclosure. Any modifications, equivalent replacements, and improvements made within the spirit and principles of the present disclosure should be included within the scope of protection of the present disclosure.

What is claimed is:

1. A light string with code writing triggered by an external signal, comprising:
a plurality of code-writable LED modules;
the code-writable LED module, after receiving an external signal, completes code writing according to a control signal loaded on its positive terminal or/and its negative terminal.

2. The light string of claim 1, wherein the code-writable LED module comprises:
a driver chip and a controlled LED, wherein the driver chip receives the control signal and drives the controlled LED to achieve controllable effects.

3. The light string of claim 2, wherein the driver chip includes a photosensitive module, the external signal is a lightwave, and after the photosensitive module receives the lightwave, the driver chip completes code writing based on the control signal.

4. The light string of claim 2, wherein the driver chip includes a thermosensitive module, the external signal is a temperature change signal, and after the thermosensitive module receives the temperature change signal, the driver chip completes code writing based on the control signal.

5. The light string of claim 2, wherein the driver chip includes a magnetic signal sensing module, the external signal is a magnetic change signal, and after the magnetic signal sensing module receives the magnetic change signal, the driver chip completes code writing based on the control signal.

6. The light string of claim 2, wherein the driver chip includes a high-frequency electromagnetic wave sensing module, the external signal is a high-frequency electromagnetic wave signal, and after the high-frequency electromagnetic wave sensing module receives the high-frequency electromagnetic wave signal, the driver chip completes code writing based on the control signal.

7. The light string of claim 5, wherein the magnetic signal sensing module is a first coil, the first coil senses an induced current generated by magnetic signal change to set the driver chip into a code-writing state, and the driver chip receives the control signal, decodes an address signal in the control signal, and completes code writing.

8. The light string of claim 2, wherein the driver chip performs pulse counting operations based on the control signal.

9. The light string of claim 2, wherein:
the driver chip performs encoding or decoding operations on the control signal, wherein the pulse high-level/low-level widths of the control signal correspond to encoded information.

10. The light string of claim 9, wherein:
different high-level durations, different low-level durations, or combinations of different high-level and low-level durations in the control signal represent different logical encoding information.

11. The light string of claim 2, wherein:
the driver chip performs modulation/demodulation operations on the control signal based on current or voltage frequency, and drives the controlled LED according to the results of these modulation/demodulation operations.

12. The light string of claim 2, wherein:
upon receiving the external signal, the driver chip is set into a code-writing state and completes the code writing process according to the control signal; the control signal includes an address signal.

13. An LED decorative light, comprising:
a controller, and the light string of claim 1;
wherein a positive terminal and a negative terminal of the controller are connected to the light string, the controller supplies power to the light string through the positive terminal and the negative terminal, and loads a control signal on the positive terminal or/and the negative terminal.

14. The LED decorative light of claim 13, further comprising a controllable switch module through which the control signal is loaded.

15. The LED decorative light of claim 14, wherein:
the controllable switch module includes a first controllable switch and an intermediate level module; when the first controllable switch is turned off, the intermediate level module forms a second level, and the control signal is loaded by switching between the supply level and the second level.

16. The LED decorative light of claim 14, wherein:
the control signal is loaded by controlling the turning ON and OFF of the controllable switch module.
